(19) United States
(12) Patent Application Publication
(10) Pub. No.: US 2025/0293396 A1
(43) Pub. Date: Sep. 18, 2025

(54) AQUEOUS SEPARATOR SLURRY COMPOSITION

(71) Applicant: Arkema Inc., King of Prussia, PA (US)

(72) Inventors: Hunter YE, King of Prussia, PA (US); Ramin AMIN-SANAYEI, King of Prussia, PA (US)

(21) Appl. No.: 18/860,216

(22) PCT Filed: Apr. 24, 2023
(86) PCT No.: PCT/US2023/019584

§ 371 Date: Oct. 25, 2024

Related U.S. Application Data
(60) Provisional application No. 63/335,896, filed on Apr. 28, 2022.

(51) Int. Cl. H01M 50/446; H01M 50/403; H01M 50/42; H01M 50/426

(52) U.S. Cl. CPC H01M 50/446; H01M 50/403; H01M 50/42; H01M 50/426

(57) ABSTRACT

The invention relates to an aqueous slurry composition comprising an aqueous-based polymeric binder and anionic oxide nanoparticles that can be used, for example, in coating of electrodes and/or separators in electrochemical devices. This coating after drying, is highly porous, electronically isolating, and exhibits high dimensional stability at elevated temperatures.

### FIELD OF THE INVENTION

The invention relate to an aqueous slurry composition for use in separator coating in electrochemical devices.

### BACKGROUND

Separators play an important role in batteries. Utilizing composite separators compared to traditional polyolefin separators has been demonstrated to improve performances of lithium-ion batteries. The invention serves to advance separator technology and improve safety for lithium-ion batteries, promoting and accelerating the adoption of batteries for EVs (Electrical Vehicles) and battery energy storages.

In an inorganic particle/polymeric matrix or polymeric binder coating composition, the polymeric matrix or polymeric binder may serve to provide: adhesion between the inorganic particles, adhesion of the coating to the free-standing porous separator, and/or adhesion of the coated separator to the electrode or electrodes (adjacent or abutting the separator coating), and/or forming in situ separators onto electrodes to make an integrated electrode separator in a lithium ion battery. Good contact between separator and electrodes may be important for optimal cycle life in a lithium battery, as the presence of voids or spaces between a separator and the electrodes may have an adverse effect on long term cycle life or battery performance.

Known inorganic nanoparticles/polyvinylidene fluoride (PVDF) coatings commonly are based on non-aqueous slurries, solvent-based systems, which use solvents such as acetone, tetrahydrofuran (THF), di-methyl-formamide (DMF), N-methyl-2-pyrrolidone (NMP), dimethyl acetamide (DMAC), combinations of these, or the like. PVDF has been used in such coatings because, for example, PVDF is inert and stable in a lithium ion battery system. However, the non-aqueous solvents used to dissolve PVDF often are hazardous, volatile, and may require careful use, disposal and/or recycling, as they may not be environmentally friendly and may produce unwanted emissions if not handled properly. Coating processes based on non-aqueous systems can be costly, may have an unfavorable environmental footprint, and may be difficult to handle due to safety concerns related to their flammability.

Hence, there is a need for novel, optimized and/or improved free-standing coated separators or cast separators that are cast directly onto electrodes of electrochemical devices for applications having or produced using an aqueous or water-based slurry system, which may be preferred compared with non-aqueous or solvent based coating systems, due to, for example, performance, cost, environmental, safety, and/or economic factors. Separators, cathodes and anodes coated with the aqueous slurry of polymeric binder and inorganic nanoparticles not only have good mechanical strength and good wet/dry adhesion, but also provide the separator or electrode with dimensional stability at elevated temperature, thereby reducing likelihood of shorting the battery at the use or at the elevated temperature.

### PRIOR ART

http://dx.doi.org/10.1016/j.jpowsour.2015.11.067 demonstrated casting of aluminum oxide based ceramic paste to form the separator by using several micron-sized (FIG. 2b) aluminum oxide. The produced separator coating on top of the electrode was limited in its flexibility and 50 μm thick, thicker than commercially available PE/PP separators. In addition, the SEM images (particularly FIG. 2b) indicates separator coating at the top is non-uniform which could be caused by use of cationic surface charged alumina. Contrary to this, the present invention utilizes anionic oxide nanoparticles and is capable of forming uniform coatings and producing flexible thin separators, i.e. lower than 25 μm thick separators, comparable to commercially available PE/PP separators.

http://dx.doi.org/10.1016/j.memsci.2016.02.047 showed the fabrication of free-standing separator using micron-sized aluminum oxide and pore-forming agent PEG, visible from SEM presented in FIG. 2 (c). The produced separator was 37 μm thick, thicker than commercially acceptable PE/PP separators. The PEG, was removed by a time intensive process where the separator was immersed in DI water, followed by drying. In contrast, the present invention uses anionic oxide nanoparticles to prepare slurries capable of producing highly porous separators without the need for pore-forming agents.

DE-FC26-05NT42403 (report: https://www.osti.gov/servlets/purl/1160224) by “Entek”, section H-15, demonstrated separators manufactured by using UHMWPE gel processing in combination with high loading levels of precipitated silica or fumed alumina as filler. The resultant filled separator had large pore size with thickness of >20 microns which could compromise the battery performance and/or safety. In contrast, the present invention uses high loading of anionic oxide nanoparticles, i.e. at least 20 weight percent of anionic oxide nanoparticles, to produce separator having high porosity without any organic solvent or gel processing, thus it is environmentally more sustainable and hence desirable.

Patent publication US20160164060A1 discloses an aqueous process for coating separators. A process for producing a coated separator for a lithium battery, which process comprises the steps of: (a) providing a porous substrate, (b) applying a coating slurry on at least one surface of the porous substrate, wherein the coating slurry comprises ceramic particles and polymeric binders in water or an aqueous solution or suspension, and (c) drying the coating slurry to form a coating layer on the porous substrate. Selection of the type of ceramic used was not based on surface charge. As a result, waterborne slurry coatings are expected not to be uniform as are evidence in SEM images of 1-5, which could be caused by use of cationic surface charged alumina. In contrast, the coating in the SEM image of 8 is uniform because it is solution cast in which surface charge is mute. Morcover, the examples provided using alumina particles have particle diameter of 0.65 μm and BET surface are of 4.6 m²/g. Contrary to this patent, our invention selects the inorganic particles based on its surface charge properties (anionic), specific surface area (>15 m²/g), and its compatibility with other components in the slurry, preventing aggregation, and hence providing uniform coating.

U.S. Pat. No. 9,954,211 patent relates to a separator including a porous organic-inorganic coating layer composed of a mixture of inorganic particles and a polymeric binder on a porous substrate, and an electrochemical device including the separator. “Inorganic particles are added to and dispersed in the first polymeric binder solution. The solvent preferably has a solubility parameter similar to that of the first polymeric binder and has a low boiling point, which are advantageous for uniform mixing and ease of solvent removal.” The patent teachings and examples are all solution-based cast. Our invention uses aqueous based polymeric binders and components to eliminate the usage of dangerous and environmentally harmful solvents as mentioned above.

In water-base slurries cationic surface charged fumed alumina exhibits poor colloidal stability when mixed with conventional waterborne polymeric binders including, but not limited, to polyvinylidene fluoride (PVDF), styrene-butadiene-rubber (SBR), and acrylics latexes; or polyvinyl alcohol (PVA), carboxymethyl cellulose (CMC) or polyacrylic acid (PAA), or combination thereafter, causing severe aggregation, preventing homogenously mixed slurry and uniform coating. Surface functionality is critical in dictating its interaction with other components in the aqueous slurry composition.

We have surprisingly found that by using anionic oxide nanoparticles, preferably aluminum oxide and/or silica in an aqueous system, the slurry is stable in that it does not form visual aggregates or agglomerates. The casted slurry makes a smooth surface without visual defects (no agglomeration of the anionic nanoparticles and the binder), hence providing desired slurry qualities for coating application.

### BRIEF SUMMARY OF INVENTION

The present invention provides a homogeneous slurry (the anionic particles and the binder is uniformly distributed in the slurry (no agglomeration is visually observed and Hegman fineness is less than 5) that can be used, for example, in coating of electrodes and/or separators in electrochemical devices. The separator comprises a porous composite having a microporous substrate and a coating layer formed on at least one surface of the porous substrate, wherein the coating layer is formed from particles and/or a mixture of particles and an aqueous or water-based polymeric binder.

The present invention further provides a process for producing a separator for a lithium ion battery, the process comprises forming a porous composite by providing a porous substrate, such as a polyolefin substrate or an electrode, and applying a coating layer on at least one surface of the porous substrate or electrode, wherein the coating layer includes particles and/or a mixture of particles (inorganic) and an aqueous or water-based polymeric binder, where the aqueous or water-based polymeric. binder may include one or more typically water-insoluble polymers (such as PVDF, SBR, acrylics) and may further include one or more typically water-soluble polymers (such as, by way of example, PVA, CMC, or PAA).

This invention further provides for the use of a free-standing coated separator in a lithium ion battery.

Also provides the use for a single operation wherein a slurry of electro-conductive material (electrode forming slurry) and the aqueous slurry composition of this invention (to form the separator) are simultaneously cast on to current collector and dried to form an integrated electrode/separator assembly.

This invention discloses a method for the preparation of aqueous slurry using anionic fumed oxides and waterborne polymeric binder, with a low Hegman fineness meaning less than 5, indicating excellent fluidity and fineness of grind. Preferably, Hegman fineness is less than 3. To achieve a slurry without visible coagulation and/or aggregation, it was surprisingly found that the surface charge of nanoparticles plays a critical role in dispersion uniformity and slurry stability. Otherwise, non-treated fumed aluminum oxide resulted in a severe aggregation, preventing homogenously mixed slurry and uniform coating a quality that is detrimental for achieving defect-free coating.

The disclosed invention can be casted alone to produce separator, membrane or film. Also it can be casted simultaneously in a multi-layer casting such as disclosed in U.S. Pat. No. 11,133,562 to produce an in situ composite separator on to the electrode for application in electrochemical cells.

The invention utilizes anionic surface charged oxides such as fumed aluminum oxide or fumed silica to prepare an aqueous homogeneous slurry. It was discovered that the surface charge of the inorganic particles plays a critical role as the aqueous slurry composition may aggregate depending on the surface charge of the oxide. Less additives or dispersants are required to address the aggregation challenges, minimizing undesired chemistries that jeopardize battery performance.

The embodiment of this invention is the preparation of aqueous-based coatings using anionic oxide nanoparticles leading to slurry qualities essential for coating. Using this invention, aqueous deposition through different means can performed to achieve a separator and/or separator coating.

Other uses for the slurry composition includes application that requires thin membranes exhibiting high porosity and electronic impedance.

Final aqueous slurry composition at dilute conditions (between 0.1 to 1% solids, preferably at 1% solids) must have a negative zeta potential less than −10 mV, preferably less than −20 mV, and more preferably less than −30 mV.

### ASPECTS OF THE INVENTION

Aspect 1: An aqueous slurry composition comprising
a) at least one polymeric binder, and
b) at least one anionic oxide nanoparticle having a volume average particle size of between 5nm to 500 nm.

Aspect 2: The aqueous slurry composition of aspect 1, wherein the anionic oxide nanoparticle comprises at least one of zinc oxide, aluminum oxide, zirconia, or silica.

Aspect 3: The aqueous slurry composition of aspect 1 or 2, wherein the anionic oxide nanoparticle comprises anionic fumed aluminum oxide and has a volume average particle size of between 5nm and 200 nm, preferably between 20 and 100 nm.

Aspect 4: The aqueous slurry composition of any one of aspects 1 to 3, wherein the anionic oxide nanoparticles have a surface area of from 15 to 600 m²/g, preferably from 20 to 300 m²/g.

Aspect 5: The aqueous slurry composition of any one of aspects 1 to 4, wherein the weight ratio of anionic oxide nanoparticles to polymeric binder is between 5:95 and 95:5.

Aspect 6: The aqueous slurry composition of any one of aspects 1 to 4, wherein the weight ratio of anionic oxide nanoparticles to polymeric binder is between 15:85 and 85:15, preferably 25:75 to 75:25.

Aspect 7: The aqueous slurry composition of any one of aspects 1 to 6, wherein the solids content of the aqueous slurry is from 10% to 70 wt % based on total weight of the aqueous slurry composition.

Aspect 8: The aqueous slurry composition of any one of aspects 1 to 7, wherein the zeta potential of the aqueous slurry composition is anionic.

Aspect 9: The aqueous slurry composition of any one of aspects 1 to 8, wherein the zeta potential of the aqueous slurry composition is negative zeta potential less than −10 mV, preferably less than −20 mV, and more preferably less than −30 mV.

Aspect 10: The aqueous slurry composition of any one of aspects 1 to 9, wherein the viscosity is less than 20,000 cP, preferably less than 10,000 cP.

Aspect 11: The aqueous slurry composition of any one of aspects 1 to 10, wherein the polymeric binder comprises both a water soluble polymeric binder and a water insoluble polymeric binder.

Aspect 12: The aqueous slurry composition of any one of aspects 1 to 11, wherein the polymeric binder comprises at least one of SBR, acrylic binders, PVDF binders, or mixture thereof.

Aspect 13: The aqueous slurry composition of any one of aspects 1 to 12, wherein the polymeric binder comprises at least one water soluble binder selected from the group consisting of PAA, CMC, PVA, HASE, and ASE, or mixtures thereof.

Aspect 14: The aqueous slurry composition of any one of aspects 1 to 13, wherein the anionic oxide nanoparticles have a fractal shape.

Aspect 15: The aqueous slurry composition of any one of aspects 1 to 14, further comprising inorganic particle having a particle size of 1 micron or greater.

Aspect 16: A separator for a secondary battery comprising a coating composition, said coating composition comprising a) at least one polymeric binder and b) at least one anionic oxide nanoparticle having a volume average particle size of between 5 nm to 500 nm.

Aspect 17: The separator of aspect 165, wherein the coating is 0.5 to 30 microns, preferably from 1 to 20 microns, and more preferably from 2 to 10 microns thick.

Aspect 18: A separator for a secondary battery comprising the composition of any one of aspect 1 to 15 in dried form.

Aspect 19: A separator formed from the aqueous slurry composition of any one of aspects 1-15.

Aspect 20: A method of making a separator for a battery comprising 1) providing an aqueous slurry composition comprising a) at least 20 weight percent anionic oxide nanoparticles and b) at most 80 wt % polymeric binder, wt % based on total weight of the anionic oxide nanoparticle and polymeric binder, 2) applying the aqueous slurry composition on a substrate, 3) drying the aqueous slurry to form the coating on the substrate.

Aspect 21: The method of aspect 20, wherein the aqueous slurry is the slurry of any one or more of aspect 1-15.

Aspect 22: The method of aspect 20 or 21, wherein the substrate is an electrode.

Aspect 23: The method of aspect 20 or 21, wherein the substrate is a free standing separator.

Aspect 24: The method of any one of aspects 20, 21 or 22, wherein the aqueous slurry is applied simultaneous with an electrode slurry in a wet on wet method.

### DESCRIPTION OF THE INVENTION

Copolymer” is used to mean a polymer having two or more different monomer units. “Polymer” is used to include homopolymer and copolymers. Resin and polymer are used interchangeably. The polymers may be homogeneous, heterogeneous, and may have a gradient distribution of co-monomer units. All references cited are incorporated herein by reference. As used herein, unless otherwise described, percent shall mean weight percent.

For purposes of this invention solids refers to the nanoparticles and the polymeric binder. Solids content is the weight % of the Solids in the aqueous slurry based on weight of the total slurry.

Nanoparticles means that the oxide particle size is less than 500 nm, preferably less than 200 nanometers. The nanoparticles can be less than 100 nm. Also, the specific surface area of nanoparticles is higher than 15 m²/g, preferably higher than 20 m²/g, and more preferably higher than 30 m²/g. Particles size is volume average particles size as measured by light scattering, Nicom, or Microtech instrument.

The slurry must be castable meaning the slurry is homogeneous (without any aggregates) and its viscosity is less than 20,000 cP at room temperature, preferably less than 10,000 cp. Haake viscometer at shear rate of 11-sec at 25C.

The invention provide for an aqueous slurry composition that can be used for example, in coating of electrodes and/or separators in electrochemical devices. The aqueous slurry composition comprises a) at least one polymeric binder and b) at least one anionic oxide nanoparticle. The polymeric binder is water-based. The water-based polymer including but not limited to PVDF, SBR, or acrylic based latexes or water soluble polymers such as PVA, CMC, and PAA, or mixture thereafter, adhering the anionic charged oxide particles together at various points of contact.

When using the water insoluble polymer latex as the binder component, water soluble binder may also be added to the aqueous slurry composition. The water soluble binder can act as a binder or as a thickener. For purposes of this invention, any polymeric thickener is considered as part of water soluble binder. Polymeric thickener may be used alone as the binder or may be used in conjunction with another water soluble binder or with a water insoluble binder.

The invention also provides for a coating made from the aqueous slurry composition on a substrate. The substrate may be a separator or an electrode or base substrate from which the coating will be removed from providing a film that can be applied onto a desired substrate. The coating may act as an in situ separator between the anode and cathode in a battery as described in U.S. Pat. No. 11,133,562 contents of which are incorporated herein by reference. The coating described herein results from the application of the aqueous slurry composition of this invention.

The anionic oxide nanoparticles useful in the present invention include but are not limited to ceramics, metal oxides, and may include aluminum oxide (Al₂O₃), alumina, titanium oxide (TiO₂), silicon oxide, silica (SiO₂), zirconium oxide (ZrO₂), Zinc oxide (ZnO), silicates, kaolin, talc as well as mixtures thereof. Preferably, the anionic oxide nanoparticle is zinc oxide, alumina or silica, most preferred is alumina (fumed alumina, fumed aluminum oxide) and silica (fumed silica).

The anionic oxide nanoparticles at dilute conditions have an anionic charge with a negative Zeta potential of less than −10 mv.

The oxide particles preferably have a high specific surface area of from 15 to 600 m2/g, preferably from 30 to 500 m2/g and have anionic charged surfaces. Examples of anionic oxide nanoparticles include anionic fumed alumina and fumed silica.

Some high specific surface area particles have 3 dimensional branching structures, this can be referred to as a fractal shape which can result in particles with large aspect ratios. Fractal shape are aggregates of primary particles that have 3 dimensional branching. Preferably, the anionic oxide nanoparticles has a fractal shape.

The anionic oxide particles suitable for the present invention range in size from about 5 nm to about 500 nm, preferably about 5 nm to about 400 nm, and most preferably about 15 nm to about 350 nm in volume average diameter. The particles can be of a variety of shapes, such as, but not limited to, rectangular, spherical, fractal, elliptical, cylindrical, oval, dog-bone shaped, or amorphous.

Furthermore, in some embodiments, the particles, as purchased from the particle manufacturer, may, for example, be pre-coated with some material to enhance the compatibility of the particle with a polymeric matrix, to improve uniformity of the particles, the dissolution of the particles in some portion of the polymer matrix, the dispersibility of the particles in the polymer matrix, to avoid particle agglomeration, and/or to stabilize the particles in the aqueous slurry composition.

### Binder Used In the Invention

The preferred polymeric binder provides interconnectivity for the anionic oxide particles and serve as the binding agent (or binder) to provide and promote adhesion between 1) the particles in the oxide particles/polymer coating layer, 2) the coating layer and the base substrate or porous membrane, and/or 3) the coated separator membrane and the battery electrodes. Good adhesion between particles may be important so that the resulting coating layer has physical integrity and does not flake apart. Good adhesion between the anionic oxide/polymer coating layer and the base substrate and between the coated separator membrane and the battery electrodes is important to ensure sufficient and optimal ion transport during charge and discharge cycles in the battery and to reduce impedance at interfaces such boundary layers.

The polymeric binders useful in the present invention include, but not limited to, emulsions of polyvinylidene (PVDF), poly ethylene-tetrafluoride ethylene (PETFE), polyvinyl fluoride (PVF), poly (alkyl)acrylates, poly (alkyl)methacrylates, poly styrene, poly vinyl alcohol (PVOH), poly acrylonitrile, poly acrylamide and copolymer of them, and water soluble polymers of carboxymethyl cellulose (CMC), polyacrylic acids (PAA), polymethacrylic acid (PMAA) homopolymers or their copolymers or mixtures thereof.

By high molecular weight means having solution viscosity of at least 100 cp. The binder should have a high solution viscosity, i.e. for water insoluble binder, higher than 100 cp at 5wt % in organic solvent (NMP) or for water soluble binders in at 2wt % in water, measured at room temperature (25° C.). Preferably, the solution viscosity is between 100 and 10,000 cp, more preferably between 100 and 5000 cp measured at 5% solids in NMP at room temperature. For water soluble polymers the viscosity is from 100cp to 10000 cp, preferably between 100 cp and 5000 cp measured in water at 2 wt % and pH of 7 at room temperature (25° C.). For this application, the pH can vary from 2 to 12 depending on polymer type and application. Preferably, the Rv of the binder is at least 0.2 dl/g up to 2 dl/g.

PVDF has been found to be useful as a polymeric binder for coatings for separators, and for in situ coating on electrodes in electrolytic devices because of its excellent electro-chemical resistance and superb adhesion among fluoropolymers. A separator forms a barrier between the anode and the cathode in the battery to prevent electronic shorts while allowing high ionic transportation.

### Polyvinylidene Fluoride

In a preferred embodiment, the polymer is a polyvinylidene fluoride homopolymer or copolymer. The term “vinylidene fluoride polymer” (PVDF) used herein includes homopolymers, copolymers, and terpolymers within its meaning. Homopolymers of PVDF exhibit high solvent resistance, low swelling in battery electrolyte (less than 50%), and high melting points (above 150 C) which in turn improves dimensional stability (less than 10% shrinkage) at elevated temperatures (at 100 C). Copolymers of PVDF are particularly preferred, as they are softer—having a lower melting point (“Tm”) and a reduced crystalline structure than the homopolymer. Such copolymers include vinylidene fluoride copolymerized with at least one comonomer. Most preferred copolymers and terpolymers of the invention are those in which vinylidene fluoride units comprise at least 50 mole percent, at least 70 mole percent preferably at least 75 mole %, more preferably at least 80 mole %, and even more preferably at least 85 mole % of the total weight of all the monomer units in the polymer.

The PVDF for use in the coating composition preferably a melt viscosity of greater than 10 kilopoise, preferably greater than 20 kilopoise, according to ASTM method D-3835 measured at 230 C and 100 sec-1.

Fluoropolymers such as polyvinylidene-based polymers are made by any process known in the art. Processes such as emulsion and suspension polymerization are preferred. These processes are known in the art.

### Acrylic

Acrylic polymers as used herein is meant to include polymers, copolymers and terpolymers formed from methacrylate and acrylate monomers in acid or ester forms, and mixtures thereof. The methacrylate monomer and acrylate monomers may make up from 51 to 100 percent of the monomer mixture, and there may be 0 to 49 percent of other ethylenically unsaturated monomers, included but not limited to, styrene, alpha methyl styrene, acrylonitrile, acrylamide. Suitable acrylate and methacrylate monomers and comonomers include, but are not limited to, methyl acrylate, ethyl acrylate and ethyl methacrylate, butyl acrylate and butyl methacrylate, iso-octyl methacrylate and acrylate, lauryl acrylate and lauryl methacrylate, stearyl acrylate and stearyl methacrylate, isobornyl acrylate and methacrylate, methoxy ethyl acrylate and methacrylate, 2-ethoxy ethyl acrylate and methacrylate, dimethylamino ethyl acrylate and methacrylate monomers. (Meth) acrylic acids such as methacrylic acid and acrylic acid can be comonomers. Acrylic polymers include multilayer acrylic polymers such as core-shell structures typically made by emulsion polymerization.

### Styrene

Styrenic polymers as used herein is meant to include polymers, copolymers and terpolymers formed from styrene and alpha methyl styrene monomers, and mixtures thereof. The styrene and alpha methyl styrene monomers may make up from 50 to 100 percent of the monomer mixture, and there may be 0 to 50 percent of other ethylenically unsaturated monomers, including but not limited to acrylates, methacrylates, acrylonitrile. Styrene polymers include, but are not limited to, polystyrene, acrylonitrile-styrene-acrylate (ASA) copolymers, styrene acrylonitrile (SAN) copolymers, styrene-butadiene copolymers such as styrene butadiene rubber (SBR), methyl methacrylate-butadiene-styrene (MBS), and styrene-(meth)acrylate copolymers such as styrene-methyl methacrylate copolymers (S/MMA).

Polyolefin as used herein is meant to include polyethyene, polypropylene, and copolymers of ethylene and propylene. The ethylene and propylene monomers may make up from 51 to 100 percent of the monomer mixture, and there may be 0 to 49 percent of other ethylenically unsaturated monomers, including but not limited to acrylates, methacrylates, acrylonitrile, anhydrides. Examples of polyolefin include ethylene ethylacetate copolymers (EVA), ethylene (meth)acrylate copolymers, ethylene anhydride copolymers and grafted polymers, propylene (meth)acrylate copolymers, propylene anhydride copolymers and grafted polymers.

### Other Additives

The aqueous slurry composition of the invention may further contain inorganic particles (P) having a particle size of equal to or greater than about 1 micron as measured by SEM. There is no particular limitation in the inorganic particles (P), as long as they are electrochemically stable. In other words, there is no particular limitation in the inorganic particles(P) that may be used in the present invention, as long as they are not subjected to oxidation and/or reduction at the range of drive voltages (for example, 0^{˜}5 V based on Li/Li+) of a battery, to which they are applied. Example inorganic particles (P) include but are not limited BaTiO₃, Pb(Zr,Ti)O₃ (PZT), Pb₁₋ₓLaₓZr_{1-y}Ti_{y}O₃ (PLZT), PB(Mg₃Nb_{2/3})O₃—PbTiO₃ (PMN-PT), hafnia (HfO₂), lithium phosphate (Li₃PO₄), lithium titanium phosphate (LiₓTi_{y}(PO₄)₃, 0<x<2, 0<y<3), lithium aluminum titanium phosphate (LiₓAl_{y}Ti_{z}(PO₄)₃, 0<x<2, 0<y<1, 0<z<3), (LiAlTiP)ₓO_{y} type glass (0<x<4, 0<y<13) such as 14Li₂O-9Al₂O₃-38TiO₂-39P₂O₅, lithium lanthanum titanate (LiₓLa_{y}TiO₃, 0<x<2, 0<y<3), lithium germanium thiophosphate (LiₓGe_{y}P_{z}S_{w}, 0<x<4, 0<y<1, 0<z<1, 0<w<5), such as Li_{3.25}Ge_{0.25}P_{0.75}S₄, lithium nitrides(LiₓN_{y}, 0<x<4, 0<y<2) such as Li₃N, SiS₂ type glass (LiₓSi_{y}S_{z}, 0<x<3, 0<y<2, 0<z<4) such as Li₃PO₄—Li₂S—SiS₂, P₂S₅ type glass (LiₓP_{y}S_{z}, 0<x<3, 0<y<3, 0<z<7) such as LiI—Li₂S—P₂S₅, SrTiO₃, SnO₂, CeO₂, MgO, NiO, CaO, ZnO, ZrO₂, Y₂O₃, Al₂O₃, TiO₂, SiC or mixtures thereof. Preferably inorganic particles (P) comprises at least one of BaTiO₃, Pb(Zr,Ti)O₃, Pb₁₋ₓLaₓZr_{y}O₃ (0<x<1, 0<y<1), PBMg₃Nb_{2/3})₃, PbTiO₃, hafnia (HfO(HfO₂), SrTiO₃, SnO₂, CeO₂, MgO, NiO, CaO, ZnO, Y₂O₃, Al₂O₃, TiO₂, SiC, ZrO₂, boron silicate, BaSO₄ More preferably inorganic particles (P) comprises at least one of SrTiO₃, SnO₂, CeO₂, MgO, NiO, CaO, ZnO, Y₂O₃, Al₂O₃, TiO₂, SiC.

The weight ratio of inorganic particles (P) to polymeric binder in the aqueous slurry composition is between 5:95 and 95:5, preferably 15:85 and 85:15, more preferably between 25:75 to 75:25.

The aqueous slurry composition of the invention may further contain effective amounts of other additives, including but not limited to fillers, leveling agents, anti-foaming agents, pH buffers, and other adjuvants typically used in formulation while meeting desired separator requirements.

The slurry composition of the invention could optionally have wetting agents, thickeners or rheology modifiers.

Optionally Wetting agents could be present in the slurry composition. Surfactants can serve as wetting agents, but wetting agents may also include non-surfactants. The presence of optional wetting agents permits uniform dispersion of anionic oxide nanoparticle into the slurry. Useful wetting agents include, but are not limited to, ionic and non-ionic surfactants such as the TRITON series (from Dow) and the PLURONIC series (from BASF), BYK-346 (from BYK Additives) and organic liquids that are compatible with the solvent, including but not limited to NMP, DMSO, Isopropyl alcohol, and acetone.

Thickeners and/or rheology modifiers may be present in the slurry composition. These may be used at from 0 to 10 parts, preferably from 0 to 5 parts of one or more thickeners or rheology modifiers per 100 parts of water (parts by weight). Addition of thickener or rheology modifier to the above dispersion prevents or slows down the settling of anionic oxide nanoparticles while providing appropriate slurry viscosity for a casting process. In addition to organic rheology modifiers, inorganic rheology modifiers can also be used alone or in combination. Examples included Carboxymethyl cellulose (CMC), polyacrylic acid (PAA), and alkali-swellable rheology modifiers include alkali-swellable emulsions (ASE), hydrophobically modified alkali-swellable emulsions (HASE), and other materials that provide pH-triggered rheological changes.

The solids content of the aqueous slurry composition can be from 10 weight percent to 70 weight percent solids, preferably from 10 to 50 weight %, even more preferably from 10 to 35% (based on weight of polymer binder plus weight of nanoparticles).

### Applications

The aqueous slurry of this invention can be used for example, to provide a coating on an electrodes and/or separator in an electrochemical device. This coating after drying, is highly porous (greater than 20% by volume) and exhibits high dimensional stability (less than 10% shrinkage at 100 C).

One application of a coating made using the aqueous slurry composition of this invention is by using waterborne PVDF latex, and anionic charged nanoparticles (Examples include fumed alumina, fumed silica, or fumed zirconia), and PAA as a rheology modifier. The resulting coating has a porosity of 20 to 80% by volume, preferably 25 to 75% and can be used as a separator in lithium ion battery or any other types of electrochemical device. This new coating utilizing the inventive aqueous slurry composition may provide increased safety and enhanced performance, and reduced cost of fabrication. Porosity is measured by gravimetric technique. The resulting coating not only does not shrink at elevated temperatures but also will expand at hot spots inside the battery to further isolate runaway electrodes from each other. The response to temperature can be tuned with resin composition, For example varying the amount of HFP comonomer in PVDF resin because a film composite made of a higher HFP (i.e. 20% HFP) content resin will swell/expand at lower temperature relative to those with lower HFP (i.e. 8% HFP) content which may require a higher temperature to obtain the same swelling/expansion. Preferred weight percent of HFP in a copolymer of VDF is from 1 to 25 wt %).

Another advantage of the aqueous slurry composition is that it can be simultaneously cast with electrodes, i.e. using a double slot die casting machine to cast two slurry layers (active electrode, and separator layers) at the same time onto a current collector using a wet-on-wet casting technique. An integrated electrode and separator structure is subsequently formed during the drying and calendaring steps. For multilayer composite structures, like electrode separators in an electrochemical device, can be cast wet on wet. When using the wet-on-wet technique the two layers become intertwined at the points of contact with no abrupt interfaces resulting in better adhesion. The film or coating can be cast simultaneously with and directly onto a substrate in a one-step wet on wet process.

### Separator

In a preferred embodiment, the aqueous slurry composition of the invention, when dried on a substrate (thereby forming a coating), can withstand the harsh environment within the battery or other electrochemical device. The aqueous slurry composition can be readily processed into a coating. When the aqueous slurry composition is coated onto an electrode, the resultant coating acts as a separator without the need for a separate free-standing separator. The aqueous slurry composition contains anionic oxide nanoparticles. Preferably, the anionic oxide nanoparticles make up at least 20% of the weight of the coated separator composition. The anionic oxide nanoparticles provide dimensional stability (minimal shrinkage) to the separator. The particles could be spherical or fractal shape structure, but are more often irregular in shape.

The anionic oxide nanoparticles in the aqueous slurry composition allow an interstitial volume to be formed within the coating during drying, thereby serving to form micropores in the coating and to maintain the physical shape as a spacer. Additionally, because the anionic oxide particles are characterized in that their physical properties are not changed even at a high temperature of 200° C. or higher, the coated separator using the anionic oxide particles has dimensional stability. Mixtures of the anionic oxides are also anticipated.

In one embodiment, the nanoparticles may be surface treated, chemically (such as by etching or functionalization), mechanically, or by irradiation (such as by plasma treatment).

The anionic oxide nanoparticles are present in the aqueous slurry composition at 5 to 95 weight percent, preferably 15 to 85 weight percent, more preferably 20 to 85 weight percent, preferably 30 to 85 weight percent, preferably 25 to 75 weight percent, based on the total weight of polymer and anionic oxide nanoparticles.

The weight ratio of anionic oxide nanoparticles to polymeric binder in the aqueous slurry composition is between 5:95 and 95:5, preferably 15:85 and 85:15, more preferably between 25:75 to 75:25.

### Coating Method

The aqueous slurry composition is applied onto at least one surface of a substrate such as a free-standing separator or alternatively an electrode by means known in the art, such as by brush, roller, ink jet, dip, knife, gravure, wire rod, squeegee, foam applicator, curtain coating, vacuum coating, slot die, or spraying. The aqueous slurry composition is then dried at room temperature, or at an elevated temperature in an oven at a temperature of between 40 to 200° C. The drying step may serve to evaporate much, or close to all, of the water originally present in the aqueous slurry composition. When the slurry composition is applied to a substrate and dried, it creates a coating on the substrate. The final dry thickness of the coating is from 0.5 to 30 microns, preferably from 1 to 20 microns, and more preferably from 2 to 10 microns.

The aqueous slurry composition can also be cast onto a substrate and then removed from the substrate and placed on an electrode or alternatively can be directly cast directly onto electrode. Non-limiting examples of the substrate is a porous and/or microporous membranes may include any commercially available single layer, bilayer, trilayer and/or multilayer (co-extruded or laminated) porous membranes which are commonly known by those skilled in the art. The substrate may be polyolefinic and include, for example, polyethylene, polypropylene, or combinations thereof, including homopolymers and/or copolymers of such polyolefin(s).

### EXAMPLES

### Test Methods

Fumed Oxides (Alumina and Silica). Fumed silica-Average particle size is 50-300 nm, a surface area of 30-450 m²/g. Fumed alumina average particle size is 50-300 nm, a surface area of 30-450 m²/g.

The zeta potential of the aqueous slurry composition at dilute conditions (preferably 1% solids) was measured using Malvern Zetasizer.

BET specific surface area, pore volume, and pore size distribution of materials can be determined using a QUANTACHROME NOVA-E gas sorption instrument. Nitrogen adsorption and desorption isotherms are generated at 77K.

General procedure: The aqueous slurry composition was prepared using a Thinky ARE-310 mixer. Five 6.5 mm zirconium beads are added into the 125 ml Thinky jar. The fumed aluminum oxide dispersion and the (1.5 wt %) CMC aqueous solution (BVH9 CMC provide by Ashland) are added to the jar and undergoes mixing in the Thinky at 2000 rpm for 2 minutes. Acrylic latex of 2008WAL35 (acid functionalized copolymer of styrene and 2-ethylhexyl acrylate) is added into the jar and it is mixed for 2000 rpm for another 2 minutes. PVDF latex of Kynar®LBG-2200LX (“LBG-2200”) (Provided by Arkema) is added and mixed for 2000 rpm for 4 minutes. The PAA was purchased from Aldrich having molecular weight of 3,000,000 Dalton.

Depending on the application and manufacturing requirement, different slurry qualities is necessary (i.e. fluidity, adhesiveness, etc.). The aqueous slurry compositions are tabulated in the tables below. Additional components may include thickeners or dispersant/surfactants such as Pluronic or IPA.

2008WAL35 is waterborne acrylic binder with MFFT below 25° C. PP06_3 is a waterborne acrylic binder with MFFT of less than 25° C. Kynar®LBG-2200LX is PVDF binder available from Arkema Inc.

In the following Examples, various coated separators for use in a lithium ion battery were formed and tested. The separator coatings' thickness were determined using Mitutoyo digital indicator. Using the example formulations, various separator thicknesses (0.5 μm to 30 μm) can be fabricated by adjusting the thickness of the wet coat.

The coated separator's flexibility was determine through ASTM D522 using TQC Cylindrical bend test. Under the test, the coated separator on aluminum foil can withstand mandrel number 2 without cracking.

Examples involving the aqueous slurry composition using anionic and cationic fumed aluminum oxides are prepared in the table below. This table demonstrates that one can produce a slurry comprising of high weight percent anionic oxide nanoparticles demonstrating excellent fluidity reported by Hegman fineness value of less than 5. The Hegman fineness measurements were performed according to ASTM D1210-05. Comparative examples, varying surface charge of aluminum oxide exhibits significantly different Hegman fineness values. Notably, cationic fumed aluminum oxide yields large aggregations reported by Hegman fineness value of 8. In contrast, when anionic aluminum oxide is used, low (less than 5) Hegman fineness values are measured. Low Hegman fineness values are necessary to ensure defect-free separator coating. Viscosity of the formulations were measured using Haake viscometer at shear rate of 11-sec at 25 C. Slurries formulated using the cationic oxides exhibit severe coagulation, exceeding the torque limit of the instrument. Weight percent is based on total solids.

TABLE 1
Example Formulations of aqueous slurry composition

| | | | | | | | |
|---|---|---|---|---|---|---|---|
| | Fumed | | | | | | |
| | Aluminum | 2008WAL35 | LBG-2200 | CMC | Slurry | | |
| | Oxide | (Binder) | (Binder) | (Thickener) | solids | Viscosity | Hegman |
| Example | (wt. %) | (wt. %) | (wt. %) | (wt. %) | (%) | (Poise) | Fineness |

Anionic

| | | | | | | | |
|---|---|---|---|---|---|---|---|
| 1 | 68 | 30 | 0 | 2 | 26 | 38.0 | 1 |
| 2 | 70 | 30 | 0 | 0 | 26 | 3.0 | 1 |
| 3 | 83.5 | 10 | 5 | 1.5 | 27 | 21.3 | 3 |

Cationic

| | | | | | | | |
|---|---|---|---|---|---|---|---|
| C-4 | 68 | 30 | 0 | 2 | 26 | X | 8 |
| C-5 | 70 | 30 | 0 | 0 | 26 | X | 8 |
| C-6 | 83.5 | 10 | 5 | 1.5 | 26 | X | 8 |

Examples 1, 2 and 3 used anionic fumed Aluminum (Aerodisp® W-640 ZX (Evonik). Examples C-4, C-5 and C-6 used Cationic fumed Aluminum (Cab-o-sperse® PG-003 (Cabot)).

The volume resistivity of the coated separator was measured using Yokogawa digital resistance meter model 755601 (up to 100 MΩ) between two gold plated electrodes (3-cm2 area) under a load of 60N. Direct comparison of the resistivity between coated separator (using example 1) and Celgard separator (commercial available separator) was determined by placing the separator on top of aluminum foil and the resistivity was measured. Both separators are not conductive as its resistivity exceed measurable value by the instrument.

In Table 2, Viscosity of the formulations were measured using Haake viscometer at shear rate of 11-sec at 25 C. Examples 7, 8, 9 and 10 used Acrodisp W-640 ZX (anionic fumed Aluminum oxide from Evonik) as the fumed oxide. Examples 11, 12, 13 and 14 used Aerodisp W 7520 (anionic fumed Silica Evonik) as the fumed oxide.

TABLE 2

| | Fumed | 2008WAL35 | LBG-2200 | CMC | | Slurry | |
|---|---|---|---|---|---|---|---|
| | Oxide | (Binder) | (Binder) | (Thickener) | PAA | solids | Viscosity |
| Ex. | (wt. %) | (wt. %) | (wt. %) | (wt. %) | (Thickener) | (%) | (Poise) |
| | Aluminum | | | | | | |
| 7 | 68 | 30 | 0 | 2 | 0 | 26 | 38.0 |
| 8 | 68 | 30 | 0 | 0 | 2 | 35 | 37.4 |
| 9 | 70 | 30 | 0 | 0 | 0 | 26 | 3.0 |
| 10 | 83.5 | 10 | 5 | 1.5 | 0 | 26 | 21.3 |
| | Silica | | | | | | |
| 11 | 68 | 30 | 0 | 2 | 0 | 18 | 16.5 |
| 12 | 68 | 30 | 0 | 0 | 2 | 22 | 17.6 |
| 13 | 70 | 30 | 0 | 0 | 0 | 24 | 3.9 |
| 14 | 83.5 | 10 | 5 | 1.5 | 0 | 17 | 14.0 |

This table shows that various binders work with anionic Silica or anionic aluminum oxide.

Viscosity of the formulations were measured using Haake viscometer at shear rate of 11-sec at 25 C.

TABLE 3

| | Fumed | | PP06_3 | LBG-2200 | CMC | | Slurry | |
|---|---|---|---|---|---|---|---|---|
| | Oxide | Alumina | (Binder) | (Binder) | (Thickener) | PAA | solids | Viscosity |
| Ex | (wt. %) | (wt. %) | (wt. %) | (wt. %) | (wt. %) | (Thickener) | (%) | (Poise) |
| 15 | 35 | 60 | 3 | 0 | 2 | 0 | 35 | 31.2 |
| 16 | 31 | 60 | 0 | 5 | 0 | 4 | 43 | 33.8 |

Examples 15 and 16 used Aerodisp W-640 ZX (anionic fumed Aluminum oxide from Evonik) as the fumed oxide. The alumina used in table 3 is an inorganic particle having a particle size of greater than 1 micron.

Various embodiments of the invention have been described in fulfillment of the various objects of the invention. It should be recognized that these embodiments are merely illustrative of the principles of the present invention. Numerous modifications and adaptations will be readily apparent to those skilled in the art without departing from the spirit and scope of this invention.

1. An aqueous slurry composition comprising:
a) at least one polymeric binder, and
b) at least one anionic oxide nanoparticle having a volume average particle size of between 5nm to 500 nm; and
wherein the zeta potential of the aqueous slurry composition is negative.

2. The aqueous slurry composition of claim 1, wherein the anionic oxide nanoparticle comprises at least one of zinc oxide, aluminum oxide, zirconia, or silica.

3. The aqueous slurry composition of claim 1, wherein the anionic oxide nanoparticle comprises anionic fumed aluminum oxide and has a volume average particle size of between 5nm and 200 nm.

4. The aqueous slurry composition of claim 1, wherein the anionic oxide nanoparticles have a surface area of from 15 to 600 m²/g.

5. The aqueous slurry composition of claim 1, wherein the weight ratio of anionic oxide nanoparticles to polymeric binder is between 5:95 and 95:5.

6. The aqueous slurry composition of claim 1, wherein the weight ratio of anionic oxide nanoparticles to polymeric binder is between 15:85 and 85:15.

7. The aqueous slurry composition of claim 1, wherein the solids content of the aqueous slurry is from 10% to 70 wt % based on total weight of the aqueous slurry composition.

8. (canceled)

9. The aqueous slurry composition of claim 1, wherein the zeta potential of the aqueous slurry composition is negative zeta potential less than negative 10 mV.

10. The aqueous slurry composition of claim 1, wherein the viscosity is less than 20,000 cP.

11. The aqueous slurry composition of claim 1, wherein the polymeric binder comprises both a water soluble polymeric binder and a water insoluble polymeric binder.

12. The aqueous slurry composition of claim 1, wherein the polymeric binder comprises at least one of SBR, acrylic binders, PVDF binders, or mixture thereof.

13. The aqueous slurry composition of claim 1, wherein the polymeric binder comprises at least one water soluble binder selected from the group consisting of PAA, CMC, PVA, HASE, and ASE, or mixtures thereof.

14. The aqueous slurry composition of claim 1, wherein the anionic oxide nanoparticles have a fractal shape.

15. The aqueous slurry composition of claim 1, further comprising inorganic particle having a particle size of 1 micron or greater.

16. A separator for a secondary battery comprising a coating composition, said coating composition comprising a) at least one polymeric binder and b) at least one anionic oxide nanoparticle having a volume average particle size of between 5nm to 500 nm.

17. (canceled)

18. A separator for a secondary battery comprising the composition of claim 1 in dried form.

19. (canceled)

20. A method of making a separator for a battery comprising 1) providing an aqueous slurry composition comprising a) at least 5 weight percent anionic oxide nanoparticles and b) at most 95 wt % polymeric binder, wt % based on total weight of the anionic oxide nanoparticle and polymeric binder, and c) optionally inorganic particles having a particle size of 1 micron or greater, 2) applying the aqueous slurry composition on a substrate, 3) drying the aqueous slurry to form the coating on the substrate.

21. The method of claim 20, wherein the substrate is an electrode.

22. The method of claim 20, wherein the substrate is a free standing separator.

23. The method of claim 20, wherein the aqueous slurry is applied simultaneous with an electrode slurry in a wet on wet method.

24. The method of claim 20, wherein the aqueous slurry is the slurry of claim 1.
